(19) United States
(12) Patent Application Publication
(10) Pub. No.: US 2026/0301432 A1
(43) Pub. Date: Oct. 1, 2026

(54) INFORMATION PROCESSING METHOD, INFORMATION PROCESSING APPARATUS, AND NON-TRANSITORY COMPUTER-READABLE STORAGE MEDIUM

(71) Applicant: HONDA MOTOR CO., LTD., Tokyo (JP)

(72) Inventors: Gakuyo FUJIMOTO, Wako-shi (JP); Misako KOIKE, Wako-shi (JP); Tsugihiro HAMASUNA, Tokyo (JP)

(73) Assignee: HONDA MOTOR CO., LTD., Tokyo (JP)

(21) Appl. No.: 19/576,393

(22) Filed: Mar. 24, 2026

(30) Foreign Application Priority Data
Mar. 28, 2025 (JP) 2025-056639

(51) Int. Cl. G06V 20/59; B60W 50/14; G06T 7/73; G06V 10/764; G06V 20/52; G06V 40/18

(52) U.S. Cl. CPC G06V 20/597; B60W 50/14; G06T 7/74; G06V 10/764; G06V 20/52; G06V 40/197; B60W 2540/22; B60W 2540/221; G06T 2207/30201; G06T 2207/30268

(57) ABSTRACT

There is provided with an information processing apparatus. A detection unit detects a face orientation and a visual line orientation of a driver of a vehicle by using a sensor included in the vehicle. A classification unit classifies whether a characteristic of a visual line relative to the face orientation of the driver is either a first characteristic or a second characteristic, based on a difference between the face orientation detected and the visual line orientation detected.

### CROSS-REFERENCE TO RELATED APPLICATION(S)

This application claims priority to and the benefit of Japanese Patent Application No. 2025-056639, filed on Mar. 28, 2025, the entire disclosure of which is incorporated herein by reference.

### BACKGROUND OF THE INVENTION

The present invention relates to an information processing method, an information processing apparatus, and a non-transitory computer-readable storage medium.

### Description of the Related Art

The technique of detecting a visual direction of a driver of a vehicle and utilizing the visual direction for various types of control has been conventionally present. Japanese Patent Laid-Open No. 2010-66968 discloses the technique of detecting a visual line direction, based on a face orientation angle and a pupil position of a driver, and determining whether the detected visual line direction is appropriate, based on a steering angle.

### SUMMARY OF THE INVENTION

According to one embodiment of the present invention, an information processing apparatus comprises: a detection unit configured to detect a face orientation and a visual line orientation of a driver of a vehicle by using a sensor included in the vehicle; and a classification unit configured to classify whether a characteristic of a visual line relative to the face orientation of the driver is either a first characteristic or a second characteristic, based on a difference between the face orientation detected and the visual line orientation detected.

### BRIEF DESCRIPTION OF THE DRAWINGS

FIG. 1 is a side view illustrating an outline of a vehicle including an information processing apparatus;

FIG. 2 is a block diagram illustrating an example of a hardware configuration of the information processing apparatus;

FIG. 3 is a block diagram illustrating an example of a functional configuration of the information processing apparatus according to a first embodiment;

FIG. 4A is a view for describing a visual line characteristic;

FIG. 4B is a view for describing a visual line characteristic;

FIG. 5 is a flowchart illustrating an example of information processing according to the first embodiment;

FIG. 6 is a block diagram illustrating an example of a functional configuration of an information processing apparatus according to a second embodiment; and

FIG. 7 is a flowchart illustrating an example of information processing according to the second embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

In estimating a face orientation or a visual line, if estimation accuracy is low, there will be a problem in that accuracy in notifying a driver of a risk is also lowered. However, for example, being hidden behind may make it difficult to continuously detect the visual line with accuracy all the time. The technique described in Japanese Patent Laid-Open No. 2010-66968 has a problem in that it is difficult to perform accurate processing in a case where it is not possible to identify, for example, an eye, and it is difficult to detect the visual line direction.

Therefore, it is an object of the present invention to obtain information for use in estimating a state in accordance with a visual line of a driver.

### First Embodiment

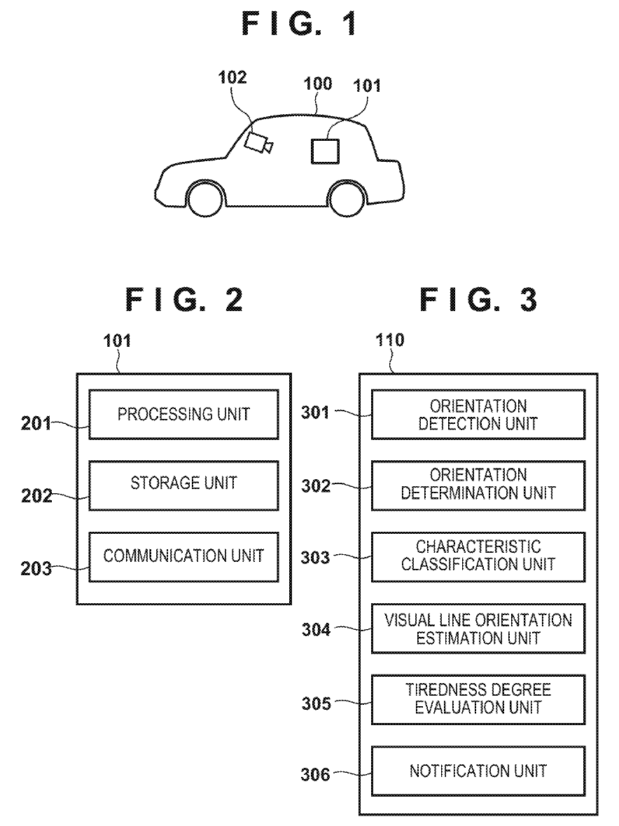

FIG. 1 is a side view illustrating an outline of a vehicle 100, as an example of a movable body, on which an information processing apparatus 101 included in a classification system according to an embodiment of the present invention is mounted.

The movable body to be controlled by the information processing apparatus 101 according to the present embodiment is a movable body that accommodates an operator in the movable body and that conducts activation control in response to an operation by such an operator. In the present embodiment, the description will be given on the assumption that the vehicle 100 is a sedan-type four-wheeled passenger vehicle, but any movable body different from the vehicle may be adopted as long as it is capable of performing similar processing.

The information processing apparatus 101 according to the present embodiment first controls a sensor 102, which is included in the vehicle 100, to detect a face orientation and a visual line orientation of the driver of the vehicle. For example, the sensor 102 may capture an image of the driver’s face and identify the face orientation from such an image of the face. In such a case, next, the sensor 102 is capable of identifying the positions of eyeballs from the image of the eyeballs and estimating left and right visual line directions of the driver from the identified face orientation and the positions of the eyeballs. Here, the following description will be given on the assumption that the sensor 102 is an imaging device that captures an image in such a manner, but the detection processing of the face orientation and the visual line orientation is an example. Any known technique capable of outputting similar information is optionally adoptable. For example, a learned machine learning model that has already learned using the face image of the driver as an input so as to output the face orientation and the visual line orientation of the driver may be used. A different sensor that detects the face orientation or the visual line orientation may be used without using a captured image.

Next, the information processing apparatus 101 according to the present embodiment classifies the characteristic of the visual line relative to the face orientation of the driver, based on a difference between the face orientation and the visual line orientation that have been detected. Hereinafter, such an information processing apparatus 101 will be described in detail.

The information processing apparatus 101 according to the present embodiment will be described, as on-vehicle equipment mounted on the vehicle 100 and an apparatus separately provided from the sensor 102. However, the information processing apparatus 101 is not limited to that having such a configuration as long as it is capable of classifying the characteristic of the visual line relative to the face orientation of the driver, based on the face orientation and the visual line orientation detected by the sensor 102. For example, the information processing apparatus 101 and the sensor 102 may be integrated into an identical apparatus. In addition, for example, the processing to be performed by the information processing apparatus 101 may be partially performed by equipment (for example, a terminal device or a server) or the like independent of the vehicle 100.

FIG. 2 is a block diagram illustrating an example of a hardware configuration of the information processing apparatus 101 according to the present embodiment. The information processing apparatus 101 includes a processing unit 201, a storage unit 202, and a communication unit 203. The processing unit 201 is a processor represented by a CPU, and executes a program stored in the storage unit 202. The storage unit 202 is a storage device such as a RAM, a ROM, or a hard disk. The communication unit 203 includes a wired or wireless communication interface capable of communicating with an external device such as another electric vehicle through a communication network. The program stored in the storage unit 202 also includes an application program for using the system according to the present embodiment.

The storage unit 202 stores various pieces of data, in addition to the program executed by the processing unit 201. The storage unit 202 according to the present embodiment stores a classification result of a current characteristic of the visual line relative to the face orientation of the driver of the vehicle 100. Here, such classification processing will be described later in detail. However, with regard to the classification of the characteristic, the current characteristic of the user (the driver) may be classified and updated in real time, or may be registered in association with the user.

FIG. 3 is a block diagram illustrating an example of a functional configuration of the information processing apparatus 101 according to the present embodiment. The information processing apparatus 101 includes an orientation detection unit 301, an orientation determination unit 302, a characteristic classification unit 303, a visual line orientation estimation unit 304, a tiredness degree evaluation unit 305, and a notification unit 306.

The orientation detection unit 301 detects the orientation of the face and the orientation of the visual line of the driver of the vehicle 100, by using the sensor 102. Hereinafter, in a case of simply describing the orientation of the face (the face orientation) or the orientation of the visual line (the visual line orientation), the face orientation or the visual line orientation of the driver of the vehicle 100 will be indicated. In the present embodiment, the sensor 102 is an imaging device included in the vehicle 100, and the orientation detection unit 301 detects the face orientation and the visual line orientation, based on a face image of the driver.

The orientation detection unit 301 is capable of detecting the face orientation and the visual line orientation using any known technique. For example, the orientation detection unit 301 is capable of detecting the face orientation, based on the face image, and detecting the visual line orientation, based on the detected face orientation and a pupil position relative to the face in the face image.

For example, the orientation detection unit 301 may detect the face orientation, by estimating the posture of a human body in the face image using a skeleton model of a human body (for example, the face or the neck, or the entire body). In detecting the face orientation, a possible range of the face orientation may be set, based on a skeleton model of an upper body or the like of the human body, and the face orientation may be detected from such a set range. In addition, the possible range of the face orientation may be set, based on data of the face orientation (and the posture of the driver) over time, and the face orientation may be detected from such a set range.

Further, for example, the vehicle 100 may include one or more driver monitor cameras (DMCs), and the orientation detection unit 301 may estimate the face orientation (and the visual line orientation), based on an imaging result by each DMC.

The orientation determination unit 302 determines whether the detected face orientation and the detected visual line orientation match each other. For example, in a case where a difference of angle between the face orientation and the visual line orientation falls within a predetermined threshold (for example, 10 degrees), the orientation determination unit 302 is capable of determining that the face orientation and the visual line orientation match each other. Hereinafter, whether the face orientation and the visual line orientation match each other to be determined by the orientation determination unit 302 will be simply referred to as “orientation matching determination”, in some cases.

Note that the orientation determination unit 302 may acquire a difference of angle between the face orientation and the visual line orientation without change to make the above-described orientation matching determination, or may separately calculate such a difference in a yaw direction (a horizontal direction) and a pitch direction (a vertical direction) to make the orientation matching determination, based on each of the differences. In calculating such a difference separately in the yaw direction and the pitch direction, the orientation determination unit 302 may calculate a score for whether the orientations match between a difference in the yaw direction and a difference in the pitch direction to make the orientation matching determination, based on these two scores (for example, based on a total value). In addition, for example, the orientation determination unit 302 may determine whether the orientations match each other in the yaw direction and the pitch direction separately. When determining that the orientations match each other in both directions, the orientation determination unit 302 may determine that the face orientation and the visual line orientation match each other. In this case, in the yaw direction and the pitch direction, a condition (for example, an angle serving as a threshold value) used for the orientation matching determination may be common, or may be different in such a manner that, for example, a larger threshold of the angle is used for determining that the orientations match each other in the yaw direction than that in the pitch direction.

Further, for example, the orientation determination unit 302 is capable of recording a difference between the detection results of the face orientation and the visual line orientation at predetermined intervals for a predetermined period of time, and is capable of making the orientation matching determination, based on a distribution of such records. Furthermore, for example, the characteristic classification unit 303 may record the differences between the face orientation and the visual line orientation individually in the yaw direction and the pitch direction, and calculate standard deviations to make the orientation matching determination, based on the standard deviations of them (for example, when the standard deviations are both equal to or smaller than a predetermined threshold value).

The characteristic classification unit 303 classifies the characteristic of the visual line relative to the face orientation of the driver, based on a difference between the face orientation and the visual line orientation that have been detected. For example, the characteristic classification unit 303 is capable of classifying the characteristic of the visual line relative to the face orientation into a first characteristic in a case where it is determined that the face orientation and the visual line orientation match each other, based on the difference between the face orientation and the visual line orientation, and classifying the characteristic into a second characteristic in a case where it is determined that the face orientation and the visual line orientation do not match each other. Hereinafter, the characteristic of the visual line relative to the face orientation of the driver will be simply referred to as a “visual line characteristic” in some cases.

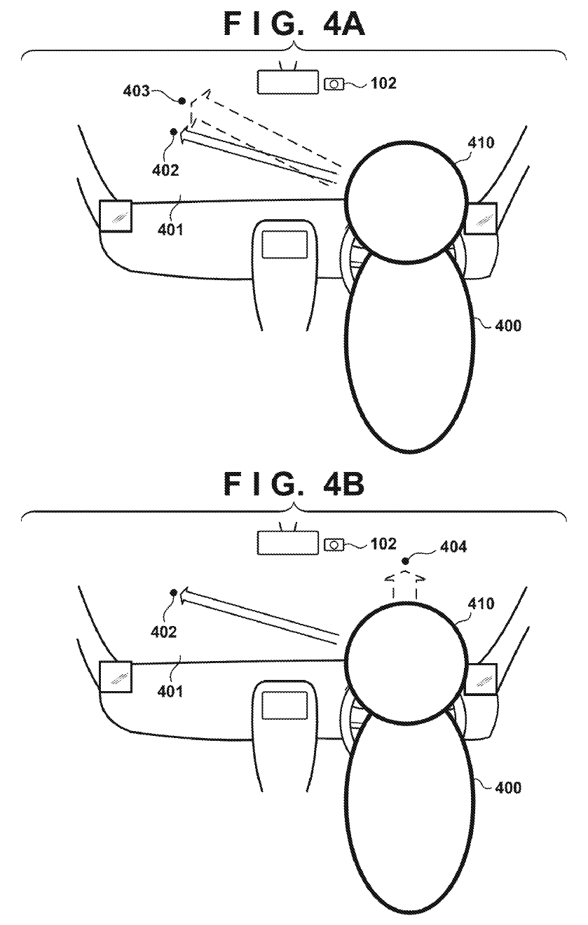

The visual line characteristic according to the present embodiment is classified as, for example, a characteristic in which the face orientation and the visual line orientation are likely to match each other and a characteristic in which the face orientation and the visual line orientation hardly match each other. Hereinafter, an example of such a visual line characteristic will be described with reference to FIGS. 4A and 4B.

FIG. 4A is a schematic view illustrating a state in which the face orientation and the visual line orientation of the driver are both directed toward the left is imaged from a rear seat by the sensor 102, which is the imaging device, in a case where it is determined that the face orientation and the visual line match each other. In FIG. 4A, the visual line of a driver 400, who is seated on the driver's seat, is directed to a position 402 on a windshield 401. In addition, in FIG. 4A, the face orientation of the driver 400 is directed to a position 403 on the windshield 401. Here, the orientation determination unit 302 compares a visual line orientation angle from a head 410 of the driver 400 to the position 402 with a face orientation angle from the head 410 to the position 403, and determines that the face orientation and the visual line orientation match each other because a difference between them falls within a threshold value. Note that in FIGS. 4A and 4B, the visual line orientation of the driver 400 is indicated by a solid arrow, and the face orientation is indicated by a chain arrow. Such a visual line characteristic in which the face orientation and the visual line orientation are likely to match each other will be hereinafter referred to as an “owl type”, in some cases.

Note that here, the visual line orientation is assumed to be an orientation from the head 410 to the position 402 similarly to the face orientation in order to simplify the description. However, the visual line orientation may be calculated as an orientation from the pupil position, and does not have to be an orientation with reference to the same position as the face orientation.

FIG. 4B is a schematic view illustrating a state in which the face orientation of the driver is the front direction but the visual line orientation is directed toward the left is imaged from a rear seat by the sensor 102, which is the imaging device, in a case where it is determined that the face orientation and the visual line orientation do not match each other. In FIG. 4B, similarly to the example of FIG. 4A, the visual line of the driver 400, which is seated on the driver's seat, is directed to the position 402 on the windshield 401. On the other hand, in FIG. 4B, the face orientation of the driver 400 is directed to a position 404 on the windshield. Here, the orientation determination unit 302 compares the visual line orientation angle from the head 410 to the position 402 of the driver 400 with the face orientation angle from the head 410 to the position 404, and determines that the face orientation and the visual line do not match each other because a difference between them is larger than a threshold value. Such a visual line characteristic in which the face orientation and the visual line orientation hardly match each other will be hereinafter referred to as a “lizard type”, in some cases.

Here, the characteristic classification unit 303 acquires the face orientation and the visual line orientation at a certain timing, and classifies the visual line characteristic of the driver at such a certain timing. In this case, the characteristic classification unit 303 is capable of updating a classification result of the visual line characteristic whenever acquiring the face orientation and the visual line orientation of the driver. However, a method of using this classification result is not particularly limited, and, for example, a classification result associated with a certain driver may be determined, based on a classification result for such a certain driver for a predetermined period of time.

The characteristic classification unit 303 may classify the characteristic at every measurement timing in this manner, or may classify the characteristic, based on determination results of the orientation matching determination over time for a predetermined period of time. For example, in a case where the length of the time or the frequency while it is determined that the face orientation and the visual line orientation match each other for a predetermined period of time is equal to or larger than a predetermined threshold value, the characteristic classification unit 303 is capable of classifying the characteristic on the assumption that the driver belongs to the owl type. In such a case, for example, the characteristic classification unit 303 may record the difference between the detection results of the face orientation and the visual line orientation, for example, every ten seconds for five minutes in total, and may classify the driver as the owl type, in a case where a period of time while the face orientation and the visual line orientation match each other by 80 percent or more in the measurement period. Such a classification of the owl type or the lizard type is not particularly limited, as long as the classification is conducted, based on the ratio or the frequency in the period of time while the face orientation and the visual line orientation match each other.

The visual line orientation estimation unit 304 is capable of estimating the visual line orientation of the driver in a different method depending on a classification result of the visual line characteristic of the driver. For example, the visual line orientation estimation unit 304 estimates the visual line orientation, based on the face orientation of the driver who has been classified as the owl type. The visual line orientation estimation unit 304 according to the present embodiment is capable of estimating the visual line orientation of the driver who has been classified as the owl type, by using, for example, information of the face orientation in the visual line orientation detection processing performed by the orientation detection unit 301. In addition, the visual line orientation estimation unit 304 estimates the visual line orientation of the driver who has been classified as the lizard type in the same method as the detection of the visual line orientation by the orientation detection unit 301.

Here, the visual line orientation estimation unit 304 is capable of estimating the visual line orientation of the driver who has been classified as the owl-type, based only on the face orientation, without using the pupil information in the face image such as the pupil position. For example, the visual line orientation estimation unit 304 is capable of creating a machine learning model (hereinafter, simply referred to as a model) that uses a face orientation as an input and that outputs a visual line orientation, based on time-series data in which the face orientation and the visual line orientation that have been detected by the orientation detection unit 301 are associated with each other for the driver who has been classified as the owl type, and is capable of estimating the visual line orientation using such a model. This model may be created beforehand for the driver, may be created, based on a detection result of the orientation detection unit 301 while the driver is driving the vehicle 100 (for a predetermined period of time, for example, one hour), or can be performed at any timing.

For example, in a case where the detection accuracy of the visual line orientation is degraded, such as a case where the periphery of the pupil of the face image is hidden behind, an adverse effect is caused also in a risk notification to the driver. On the other hand, for a driver having a characteristic in which the face orientation and the visual line are likely to match each other, it is possible to estimate the visual line with accuracy from the face orientation as compared with a driver having a characteristic in which the face orientation and the visual line are not likely to match each other, and it is possible to estimate the visual line with accuracy only from the face orientation.

The tiredness degree evaluation unit 305 is capable of evaluating a tiredness degree of the driver, based on detection results over time of the face orientation and the visual line orientation of the driver. Here, it is assumed that the tiredness degree of the driver is evaluated by selecting either “tired” or “not tired”, but, for example, a score of the tiredness degree may be evaluated as a predetermined degree such as 1 to 5.

It can be considered that as the driver gets tired, the movement of the face orientation decreases, and the driver tries to follow the movement of an object only with the visual line. From such a viewpoint, when the classification of the driver is changed from the owl type to the lizard type, the tiredness degree evaluation unit 305 may evaluate that the driver is tired. Here, for example, the classification of the driver is updated every five minutes, and when the classification that was the owl type last time is changed to the lizard type, the tiredness degree evaluation unit 305 is capable of evaluating that the driver is tired.

In addition, in a case where the visual line does not follow the movement of the object and the visual line orientation does not change, it can be considered that attention or concentration is lowered due to tiredness or the like, and the driver is driving carelessly. From such a viewpoint, the tiredness degree evaluation unit 305 may evaluate the tiredness degree of the driver in accordance with a fluctuation of the visual line orientation of the driver. The tiredness degree evaluation unit 305 calculates, for example, a standard deviation of the visual line orientation for a predetermined period of time (for example, five minutes), and evaluates that the driver is tired when the calculated standard deviation is equal to or smaller than a threshold value.

In addition, from a psychological point of view, it can be also considered that a tendency of thoughts appears on the visual line orientation. Here, for example, it is assumed that when the visual line is directed to the upper right, which means remembering something, when the visual line is directed to the lower right, which means becoming introverted, when the visual line is directed to the left, which means paying attention to an unfamiliar sound, and when the visual line is directed to the lower left, which means feeling something wrong in the body. From such a viewpoint, the tiredness degree evaluation unit 305 may evaluate on the assumption that the driver is in a specific state in accordance with the visual line orientation relative to the face orientation. For example, in a case of determining that the driver is facing the lower right, based on the visual line orientation relative to the face orientation of the driver (for example, in a case where the visual line orientation is directed at an angle within a predetermined range set as a lower right direction relative to the face orientation angle), the tiredness degree evaluation unit 305 is capable of evaluating that the driver is not concentrating on driving and the driver is tired or driving carelessly. In addition, for example, in a case where the visual line orientation (for example, an average direction for a predetermined period of time) in the yaw direction is closer to the left than a reference direction by a threshold value or more, the tiredness degree evaluation unit 305 is capable of evaluating that the driver cannot concentrate on driving and is tired. In this manner, when the visual line orientation relative to the face orientation of the driver has a predetermined relationship, the tiredness degree evaluation unit 305 is capable of evaluating that the driver is tired.

Note that the visual line being directed to a certain direction for a moment may happen also in a non-tired state. From such a viewpoint, a condition for determining that the visual line orientation relative to the face orientation is directed to a predetermined direction may be satisfied, when such a state of being directed to such a predetermined direction continues for a certain period of time. The same reasoning also applies to the determination in a second embodiment to be described later.

The notification unit 306 is capable of giving a predetermined notification to the driver. When the driver is evaluated to be tired, the notification unit 306 according to the present embodiment gives a notification that the driver is tired. For example, the notification unit 306 may give a notification such as “You look tired from driving” or “You are losing focus” to be displayed by text on a display, may give a notification by audio reproduction, or may reproduce a predetermined notification sound.

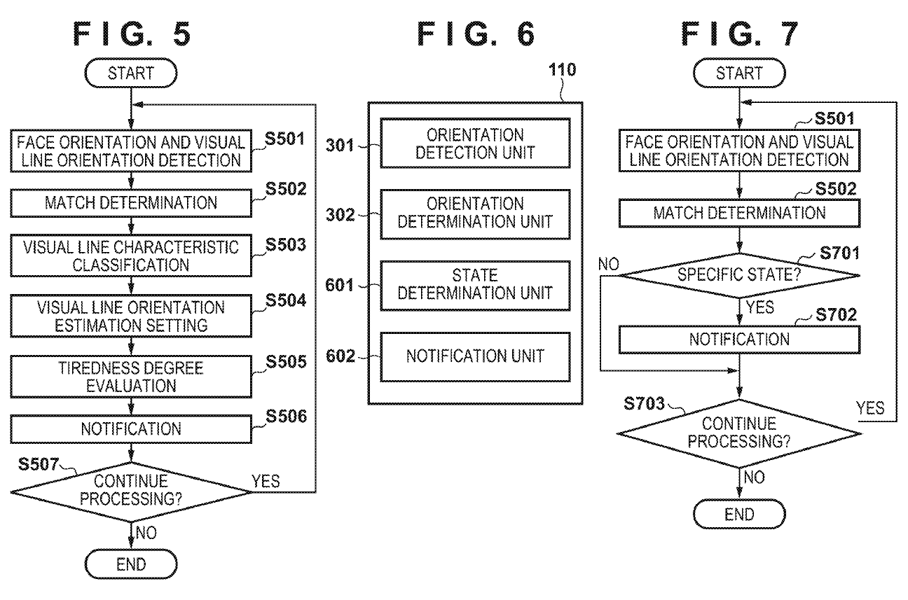

FIG. 5 is a flowchart illustrating an example of classification processing of the visual line characteristic performed by the information processing apparatus 101 according to the present embodiment. The processing illustrated in FIG. 5 starts, for example, when an operation to start driving the vehicle 100 is performed.

In S501, the orientation detection unit 301 causes the sensor 102 to detect the face orientation and the visual line orientation of the driver. Here, the sensor 102 is an imaging device, and the face orientation and the visual line orientation are detected, based on a face image.

In S502, the orientation determination unit 302 determines whether the face orientation and the visual line orientation match each other, based on a difference between the face orientation and the visual line orientation detected in S501. Here, it is assumed that the orientation determination unit 302 determines that the face orientation and the visual line orientation match each other in a case where a standard deviation of the differences between the face orientation and the visual line orientation for a predetermined period of time is equal to or smaller than a predetermined threshold value.

In S503, the characteristic classification unit 303 classifies a visual line characteristic of the driver, based on the difference between the face orientation and the visual line orientation detected in S501. Here, in a case where it is determined in S502 that the face orientation and the visual line orientation match each other, the characteristic classification unit 303 determines that the visual line characteristic is the owl type (a first characteristic), and in a case where it is determined that the face orientation and the visual line orientation do not match each other, the characteristic classification unit 303 determines that the visual line characteristic is the lizard type (a second characteristic).

In S504, the visual line orientation estimation unit 304 makes settings to estimate the visual line orientation in a method corresponding to a classification result of the visual line characteristic in S503. Here, in a case where the visual line characteristic is classified as the owl type, the visual line orientation estimation unit 304 detects the visual line orientation, based only on the face orientation. In a case where the visual line characteristic is classified as the lizard type, the visual line orientation estimation unit 304 continuously performs the visual line orientation detection processing performed in S501. Such a detection result is assumed to be an estimation result of the visual line orientation.

In S505, the tiredness degree evaluation unit 305 evaluates a tiredness degree of the driver, based on detection results over time of the face orientation and the visual line orientation of the driver.

When the driver is evaluated to be tired in S505, the notification unit 306 gives a notification that the driver is tired, in the vehicle 100, in S506.

In S507, the characteristic classification unit 303 determines whether to continue the classification processing of the visual line characteristic. In a case where the classification processing of the visual line characteristic continues, the processing returns to S501. In a case where the classification processing of the visual line characteristic does not continue, the processing in FIG. 5 ends. For example, the characteristic classification unit 303 is capable of determining that the classification processing of the visual line characteristic continues while the driver is continuously driving the vehicle 100.

According to such a configuration, it becomes possible for the sensor included in the vehicle to detect the face orientation and the visual line orientation of the driver, and to classify the visual line characteristic of the driver, based on a difference between the face orientation and visual line orientation that have been detected. This enables obtaining of information for use in estimating a state in accordance with the visual line of the driver. In particular, in a case where the visual line characteristic of the driver is classified as the owl type, the visual line orientation is estimated, based on the face orientation of the driver. Even when the detection accuracy of the visual line orientation is degraded due to being hidden behind or the like, it becomes possible to estimate the visual line orientation and improve the accuracy of a risk notification or the like.

### Second Embodiment

The information processing apparatus 101 according to the first embodiment has been described to perform processing of classifying the visual line characteristic of the driver and controlling the estimation method of the visual line orientation in accordance with a classification result. On the other hand, the information processing apparatus 101 according to the second embodiment determines whether the driver is in a specific state (for example, a state of not concentrating on driving) in accordance with a fluctuation situation over time of a positional relationship between the face orientation and the visual line orientation of the driver. Next, in a case where the driver is in a specific state, the information processing apparatus 101 is capable of giving a notification indicating that the driver is in such a specific state.

The configuration of the vehicle 100 including the information processing apparatus 101 according to the present embodiment is similar to that in the first embodiment. Thus, similar processing can be performed, and overlapping descriptions will be omitted.

FIG. 6 is a block diagram illustrating an example of a functional configuration included in the information processing apparatus 101 according to the present embodiment. The functional units illustrated in FIG. 6 have similar configurations to those illustrated in FIG. 3 in the first embodiment except that a state determination unit 601 and a notification unit 602 are included instead of the characteristic classification unit 303, the visual line orientation estimation unit 304, the tiredness degree evaluation unit 305, and the notification unit 306. Similar processing can be performed, and overlapping descriptions will be omitted.

The state determination unit 601 determines whether the driver is in a specific state in accordance with a fluctuation situation over time of the positional relationship between the face orientation and the visual line orientation of the driver. Here, it is assumed to use a state in which the driver is not concentrating on driving (driving carelessly). In a case where the orientation determination unit 302 determines that a state in which the face orientation and the visual line orientation do not to match each other continues for a predetermined threshold period of time or more, the state determination unit 601 is capable of determining that the driver is not concentrating on driving. In addition, for example, in a case where the length of time or the frequency while it is determined that the face orientation and the visual line orientation match each other for a predetermined period of time is smaller than a predetermined threshold value, the state determination unit 601 may determine that the driver is not concentrating on driving.

Further, the state determination unit 601 is capable of determining whether the driver is in a specific state in accordance with the visual line orientation relative to the face orientation in a method similar to the method that has been described and that is performed by the tiredness degree evaluation unit 305 in the first embodiment. For example, in a case where it is determined that the visual line of the driver is directed to the lower right, the state determination unit 601 is capable of determining that the driver is not concentrating on driving, and is driving carelessly. Furthermore, for example, in a case where the visual line orientation in the yaw direction is directed toward the left by a threshold value or more from a reference direction, the state determination unit 601 is capable of determining that the driver is in a state of not being able to concentrate on driving, and is driving carelessly.

Note that as described above, the description will be given on the assumption that a state in which the driver is not concentrating on driving is used as the “specific state”, but a state different from this state may be used. For example, in a case where it is determined that the visual line of the driver is directed to the lower left, the state determination unit 601 is capable of determining that the driver is feeling something wrong physically, as the specific state.

When it is determined that the driver is in the specific state, the notification unit 602 gives a notification that the driver is in the specific state. For example, similarly to the notification unit 306 in the first embodiment, the notification unit 602 may give a notification such as “You are losing focus” to be displayed by text on a display, may give a notification by audio reproduction, or may reproduce a predetermined notification sound.

FIG. 7 is a flowchart illustrating an example of processing performed by the information processing apparatus 101 according to the present embodiment. In the processing illustrated in FIG. 7, S701 to S703 are performed to be subsequent to S501 to S502, and overlapping descriptions will be omitted.

In step S701, the state determination unit 601 determines whether the driver is in a specific state in accordance with a fluctuation situation over time of the positional relationship between the face orientation and the visual line orientation of the driver. In a case where the driver is in the specific state, the processing proceeds to S702, and in the other case, the processing proceeds to S703. As described above, here, whether the driver is driving carelessly is determined.

In S702, the notification unit 602 gives a notification that the driver is in the specific state, and the processing proceeds to S703.

In S703, the state determination unit 601 determines whether to continue the processing illustrated in FIG. 7. In a case where the processing continues, the processing returns to S501. In a case where the processing does not continue, the processing of FIG. 7 ends. For example, in a case where the driver is continuously driving the vehicle 100, the state determination unit 601 is capable of determining that the classification processing of the visual line characteristic continues.

According to such a configuration, the sensor included in the vehicle detects the face orientation and the visual line orientation of the driver, and it becomes possible to determine whether the driver is in a specific state in accordance with a fluctuation situation over time of the positional relationship between the face orientation and the visual line orientation that have been detected. This enables obtaining of information for use in estimating a state in accordance with the visual line of the driver. When the state in which the face orientation and the visual line orientation do not match each other continues, it is determined that the driver is in a state of driving carelessly. Thus, it becomes possible to detect that the driver is not in a normal state, and to perform various types of processing such as giving a notification of such a fact.

### Summary of Embodiments

The above-described embodiments disclose at least an information processing apparatus, an information processing method, and a program in the following.

1. An information processing apparatus according to the above embodiment comprises:

a detection unit configured to detect a face orientation and a visual line orientation of a driver of a vehicle by using a sensor included in the vehicle; and

a classification unit configured to classify whether a characteristic of a visual line relative to the face orientation of the driver is either a first characteristic or a second characteristic, based on a difference between the face orientation detected and the visual line orientation detected.

According to this embodiment, it becomes possible to obtain information for use in estimating the state in accordance with the visual line of the driver.

2. The information processing apparatus according to the above embodiment, further comprises a first determination unit configured to determine whether the face orientation detected and the visual line orientation detected match each other, wherein

in a case where it is determined that the face orientation and the visual line orientation match each other, the classification unit classifies the characteristic of the visual line as the first characteristic, and in a case where it is determined that the face orientation and the visual line orientation do not match each other, the classification unit classifies the characteristic of the visual line as the second characteristic.

According to this embodiment, it becomes possible to classify the characteristic of the visual line in accordance with a matching situation between the face orientation and the visual line orientation.

3. In the information processing apparatus according to the above embodiment,

the first determination unit determines whether the face orientation and the visual line orientation match each other, based on a difference either in a yaw direction or in a pitch direction between the face orientation and the visual line orientation.

According to this embodiment, it becomes possible to classify the characteristic of the visual line in accordance with the matching situation between the face orientation and the visual line orientation in the yaw direction or the pitch direction.

4. The information processing apparatus according to the above embodiment, further comprises a first estimation unit configured to estimate the visual line orientation of the driver whose visual line characteristic is classified as the first characteristic, based on the face orientation.

According to this embodiment, it becomes possible to estimate the visual line orientation of the driver whose face orientation and visual line orientation are likely to match each other with accuracy regardless of the situation.

5. The information processing apparatus according to the above embodiment, further comprises a second estimation unit configured to estimate the visual line orientation of the driver in different methods between a case where the characteristic of the visual line relative to the face orientation of the driver is classified as the first characteristic and a case where the characteristic is classified as the second characteristic.

According to this embodiment, it becomes possible to estimate the visual line in an appropriate method in accordance with the characteristic of the visual line.

6. The information processing apparatus according to the above embodiment, further comprises an evaluation unit configured to evaluate a tiredness degree of the driver, based on a detection result over time of the face orientation and the visual line orientation detected by the detection unit.

According to this embodiment, it becomes possible to evaluate the tired state of the driver in accordance with the state of the face orientation and the visual line orientation.

7. In the information processing apparatus according to the above embodiment,

when the characteristic of the visual line changes from the first characteristic to the second characteristic, the evaluation unit evaluates that the driver is tired.

According to this embodiment, it becomes possible to detect that the driver is in a tired state in accordance with the change in the characteristic of the visual line.

8. In the information processing apparatus according to the above embodiment,

the evaluation unit evaluates the tiredness degree of the driver, based on a fluctuation of the visual line orientation of the driver.

According to this embodiment, it becomes possible to evaluate the tired state of the driver in accordance with how much the visual line orientation fluctuates.

9. In the information processing apparatus according to the above embodiment,

in a case where a standard deviation of the visual line orientation of the driver for a predetermined period of time is equal to or smaller than a threshold value, the evaluation unit evaluates that the driver is tired.

According to this embodiment, it becomes possible to determine that the driver is tired in accordance with a large fluctuation in the visual line orientation of the driver.

10. In the information processing apparatus according to the above embodiment,

in a case where the visual line orientation relative to the face orientation of the driver has a predetermined relationship, the evaluation unit evaluates that the driver is tired.

According to this embodiment, it becomes possible to determine that the driver is tired in accordance with the visual line orientation relative to the face orientation of the driver being in the specific state.

11. The information processing apparatus according to the above embodiment, further comprises a first notification unit configured to give a notification that the driver is tired, when the evaluation unit evaluates that the driver is tired, based on the tiredness degree.

According to this embodiment, it becomes possible to give an appropriate notification in response to detection of tiredness of the driver.

12. An information processing apparatus according to the above embodiment comprises:

a detection unit configured to detect a face orientation and a visual line orientation of a driver of a vehicle by using a sensor included in the vehicle; and

a second determination unit configured to determine whether the driver is in a specific state in accordance with a fluctuation situation over time of a positional relationship between the face orientation detected and the visual line orientation detected.

According to this embodiment, it becomes possible to obtain information for use in estimating the state in accordance with the visual line of the driver.

13. In the information processing apparatus according to the above embodiment,

the specific state is a state of not concentrating on driving.

According to this embodiment, it becomes possible to detect that the driver is driving carelessly in accordance with a fluctuation situation of the positional relationship between the face orientation and the visual line orientation.

14. The information processing apparatus according to the above embodiment, further comprises a third determination unit configured to determine whether the visual line is directed toward left while the driver is driving, wherein

in a case where it is determined that the visual line orientation is directed toward the left while the driver is driving, the second determination unit determines that the driver is not concentrating on driving.

According to this embodiment, it becomes possible to detect that the driver is driving carelessly from a psychological viewpoint.

15. The information processing apparatus according to the above embodiment, further comprises a second notification unit configured to give a notification that the driver is in the specific state, when it is determined that the driver is in the specific state.

According to this embodiment, it becomes possible to give an appropriate notification in accordance with the state of the driver.

16. An information processing method according to the above embodiment comprises:

detecting a face orientation and a visual line orientation of a driver of a vehicle by using a sensor included in the vehicle; and

classifying whether a characteristic of a visual line relative to the face orientation of the driver is either a first characteristic or a second characteristic, based on a difference between the face orientation detected and the visual line orientation detected.

According to this embodiment, it becomes possible to obtain information for use in estimating the state in accordance with the visual line of the driver.

17. An information processing method according to the above embodiment comprises:

detecting a face orientation and a visual line orientation of a driver of a vehicle by using a sensor included in the vehicle; and

determining whether the driver is in a specific state in accordance with a fluctuation situation over time of a positional relationship between the face orientation detected and the visual line orientation detected.

According to this embodiment, it becomes possible to obtain information for use in estimating the state in accordance with the visual line of the driver.

18. A non-transitory computer-readable storage medium according to the above embodiment stores a program, that causes an information processing device to function as:

a detection unit configured to detect a face orientation and a visual line orientation of a driver of a vehicle by using a sensor included in the vehicle; and

a classification unit configured to classify whether a characteristic of a visual line relative to the face orientation of the driver is either a first characteristic or a second characteristic, based on a difference between the face orientation detected and the visual line orientation detected.

According to this embodiment, it becomes possible to obtain information for use in estimating the state in accordance with the visual line of the driver.

19. A non-transitory computer-readable storage medium according to the above embodiment stores a program, that causes an information processing device to function as:

a detection unit configured to detect a face orientation and a visual line orientation of a driver of a vehicle by using a sensor included in the vehicle; and

a second determination unit configured to determine whether the driver is in a specific state in accordance with a fluctuation situation over time of a positional relationship between the face orientation detected and the visual line orientation detected.

According to this embodiment, it becomes possible to obtain information for use in estimating the state in accordance with the visual line of the driver.

Heretofore, although the embodiments of the invention have been described, the invention is not limited to the foregoing embodiments, and various variations/changes are possible within the spirit of the invention.

What is claimed is:

1. An information processing apparatus comprising:
a detection unit configured to detect a face orientation and a visual line orientation of a driver of a vehicle by using a sensor included in the vehicle; and
a classification unit configured to classify whether a characteristic of a visual line relative to the face orientation of the driver is either a first characteristic or a second characteristic, based on a difference between the face orientation detected and the visual line orientation detected.

2. The information processing apparatus according to claim 1, further comprising a first determination unit configured to determine whether the face orientation detected and the visual line orientation detected match each other, wherein
in a case where it is determined that the face orientation and the visual line orientation match each other, the classification unit classifies the characteristic of the visual line as the first characteristic, and in a case where it is determined that the face orientation and the visual line orientation do not match each other, the classification unit classifies the characteristic of the visual line as the second characteristic.

3. The information processing apparatus according to claim 2, wherein the first determination unit determines whether the face orientation and the visual line orientation match each other, based on a difference either in a yaw direction or in a pitch direction between the face orientation and the visual line orientation.

4. The information processing apparatus according to claim 1, further comprising a first estimation unit configured to estimate the visual line orientation of the driver whose visual line characteristic is classified as the first characteristic, based on the face orientation.

5. The information processing apparatus according to claim 1, further comprising a second estimation unit configured to estimate the visual line orientation of the driver in different methods between a case where the characteristic of the visual line relative to the face orientation of the driver is classified as the first characteristic and a case where the characteristic is classified as the second characteristic.

6. The information processing apparatus according to claim 1, further comprising an evaluation unit configured to evaluate a tiredness degree of the driver, based on a detection result over time of the face orientation and the visual line orientation detected by the detection unit.

7. The information processing apparatus according to claim 6, wherein when the characteristic of the visual line changes from the first characteristic to the second characteristic, the evaluation unit evaluates that the driver is tired.

8. The information processing apparatus according to claim 6, wherein the evaluation unit evaluates the tiredness degree of the driver, based on a fluctuation of the visual line orientation of the driver.

9. The information processing apparatus according to claim 6, wherein in a case where a standard deviation of the visual line orientation of the driver for a predetermined period of time is equal to or smaller than a threshold value, the evaluation unit evaluates that the driver is tired.

10. The information processing apparatus according to claim 6, wherein in a case where the visual line orientation relative to the face orientation of the driver has a predetermined relationship, the evaluation unit evaluates that the driver is tired.

11. The information processing apparatus according to claim 6, further comprising a first notification unit configured to give a notification that the driver is tired, when the evaluation unit evaluates that the driver is tired, based on the tiredness degree.

12. An information processing apparatus comprising:
a detection unit configured to detect a face orientation and a visual line orientation of a driver of a vehicle by using a sensor included in the vehicle; and
a second determination unit configured to determine whether the driver is in a specific state in accordance with a fluctuation situation over time of a positional relationship between the face orientation detected and the visual line orientation detected.

13. The information processing apparatus according to claim 12, wherein the specific state is a state of not concentrating on driving.

14. The information processing apparatus according to claim 12, further comprising a third determination unit configured to determine whether the visual line is directed toward left while the driver is driving, wherein
in a case where it is determined that the visual line orientation is directed toward the left while the driver is driving, the second determination unit determines that the driver is not concentrating on driving.

15. The information processing apparatus according to claim 12, further comprising a second notification unit configured to give a notification that the driver is in the specific state, when it is determined that the driver is in the specific state.

16. An information processing method comprising:
detecting a face orientation and a visual line orientation of a driver of a vehicle by using a sensor included in the vehicle; and
classifying whether a characteristic of a visual line relative to the face orientation of the driver is either a first characteristic or a second characteristic, based on a difference between the face orientation detected and the visual line orientation detected.

17. An information processing method comprising:
detecting a face orientation and a visual line orientation of a driver of a vehicle by using a sensor included in the vehicle; and
determining whether the driver is in a specific state in accordance with a fluctuation situation over time of a positional relationship between the face orientation detected and the visual line orientation detected.

18. A non-transitory computer-readable storage medium storing a program, that causes an information processing device to function as:
a detection unit configured to detect a face orientation and a visual line orientation of a driver of a vehicle by using a sensor included in the vehicle; and
a classification unit configured to classify whether a characteristic of a visual line relative to the face orientation of the driver is either a first characteristic or a second characteristic, based on a difference between the face orientation detected and the visual line orientation detected.

19. A non-transitory computer-readable storage medium storing a program, that causes an information processing device to function as:
a detection unit configured to detect a face orientation and a visual line orientation of a driver of a vehicle by using a sensor included in the vehicle; and
a second determination unit configured to determine whether the driver is in a specific state in accordance with a fluctuation situation over time of a positional relationship between the face orientation detected and the visual line orientation detected.
